(19) United States
(12) Patent Application Publication
(10) Pub. No.: US 2006/0229382 A1
(43) Pub. Date: Oct. 12, 2006

(54) Water-based coloring agent preparations for inkjet printing

(76) Inventors: Karl-Heinz Schweikart, Eschborn (DE); Andreas Harz, Schwalbach (DE); Martin Alexander Winter, Kelkheim (DE); Heidemarie Menzel, Bad Soden (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 10/553,817

(22) PCT Filed: Apr. 8, 2004
(86) PCT No.: PCT/EP04/03771

§ 371 Date: Oct. 19, 2005

(30) Foreign Application Priority Data
Apr. 22, 2003 (DE) 10318233.0

(51) Int. Cl. C03C 17/00

(52) U.S. Cl. 523/160

(57) ABSTRACT

The invention relates to aqueous coloring agent preparations essentially comprising (A) 0.1% to 50% by weight at least one organic and/or inorganic colorant, (B) 0.1% to 30% by weight of at least one succinamate, (C) 0.1% to 30% by weight of at least one polyethylene glycol alkyl ether, (D) 0% to 30% by weight of at least one alkoxylated styrene-phenol condensate, (E) 0% to 30% by weight of at least one organic solvent, (F) 0% to 30% by weight of at least one hydrotropic substance, (G) 0% to 10% by weight of other additives commonly used for inkjet preparations, and (H) 10% to 90% by weight of deionized water, the percentages being in relation to the total weight (100% by weight) of the coloring agent preparation. The inventive coloring agent preparations are particularly suitable for use in inkjet inks.

The present invention relates to waterborne colorant preparations.

The ink jet printing process, like for example electrophotography (laser printers and copiers), is a nonimpact printing process and has become more and more important in recent years, especially in the small office, home office (SOHO) sector, but also in the wide format sector, owing to the increasing use of computers.

Ink jet printing technology distinguishes between the so-called continuous printing processes and the drop-on-demand processes, the drops in question being ink drops which are generated by a computer-controlled electrical signal. There are basically two kinds of drop-on-demand ink jet processes, namely thermal ink jet, also known as bubble jet, and piezoelectric ink jet.

Thermal and piezoelectric ink jet have hitherto employed inks which are based on solutions of water-soluble dyes, which is why the prints possess high brilliance and optical density, but insufficient lightfastness and poor water resistance. These disadvantages of dye-based ink jet inks can only be partly overcome by the use of specialty papers. One way of overcoming the aforementioned disadvantages of dye-based inks would be to use pigmented inks.

Pigmented inks for ink jet printing would have to meet a whole series of requirements. They have to have a viscosity and surface tension suitable for printing, they have to be stable in storage, i.e., they should not coagulate and the dispersed pigment should not sediment, they must not clog the printer nozzles, which can be problematical in the case of pigment particle inks especially, and they should be environmentally friendly, i.e., be substantially waterborne and contain very low concentrations of organic solvents. Similarly, the purity of the preparations has to meet high requirements, since excessive concentrations of inorganic or organic salts and ions, especially chloride ions, lead to corrosion and hence to premature destruction of the print heads or in the case of bubble jet printers to harmful deposits on the heating elements.

Very high standards are required especially of the color strength, the hue, the brilliance, transparency and fastness properties, for example lightfastness, waterfastness and crockfastness of the pigments and prints. High lightfastness is important especially when the ink jet process is to be used to produce prints of photographic quality or for outdoor use. To meet these properties, mixtures of various dyes and/or pigments having different properties are used in some instances.

A fine state of subdivision is a basic prerequisite for pigment preparations for use in ink jet printing, since the avoidance of nozzle clogging requires that the average pigment particle size not exceed 200 nm, preferably 150 nm, and that the particle size distribution be very narrow, so that even the maximum particle size does not exceed 500 nm. As well as a fine state of subdivision, it is particularly the flocculation resistance which is a very important quality criterion of an ink jet preparation, which is why crystal growth or agglomeration of the pigment particles has to be effectively prevented by means of suitable additives. This is usually accomplished by means of certain dispersing assistants. A pigment dispersion property closely related to its flocculation resistance is its stability in storage, since the pigment particles must not agglomerate during prolonged storage, even at elevated or reduced temperatures compared with room temperature. During printing, pigmented inks are subjected to extreme thermal and mechanical stresses; the dispersing assistant has to ensure pigment dispersion stability even in these circumstances. Transient temperature jumps of up to 500° C. occur in thermal ink jet. Even in these conditions, the pigment may neither flocculate nor cogate (sediment) on the heating elements of the printer nor clog the printer nozzles. In printing, the pigmented ink is flung through a narrow nozzle; extremely high shearing stresses occur in the process, but they must not cause the dispersing assistant to be sheared off the pigment surface.

Accordingly, the dispersing assistant used is of decisive importance, not only because it determines the physical properties, for example surface tension and viscosity, of the dispersions, but also because it shall stabilize the inks against flocculation in the course of storage and decomposition in the course of the printing operation.

In addition the dispersant has a considerable influence on droplet formation during the printing process. Uniform droplet formation free of satellites is a prerequisite for high-quality ink jet prints in the photoprint sector for example.

EP-A-1 116 757 discloses pigment dispersions for ink jet printing which comprise a combination of ethoxylated naphthalene derivatives and sulfosuccinates or polyethylene glycol carboxylates as a dispersant system.

U.S. Pat. No. 5,938,830 describes pigmented inks based on N-(1,2-dicarboxyethyl)-N-disubstituted sulfosuccinamates as a dispersant.

EP-A-0 448 055 describes aqueous ink jet recording fluids consisting of pigments and dispersants bearing at least one sulfonic acid grouping. The pigment content is in the range from 2% to 4%. Storage stabilities are unsatisfactory in some cases.

Prior art pigmented preparations for ink jet printing often fail to meet printer manufacturers' requirements in that they are deficient in subdivision, thermostability and stability in storage. Especially the stability problems of pigmented ink jet inks are closely tied to adequate stabilization of the pigment particles in the aqueous organic solutions. The present invention therefore has for its object to use suitable dispersing assistants to provide novel pigment preparations which combine the abovementioned quality features and requirements with regard to the ink jet printing process and therefore can find advantageous application in the ink jet process.

We have found that this object is achieved, surprisingly, by the use of the hereinbelow described combination of dispersants to produce colorant preparations which meet the abovementioned requirements of ink jet printing to a substantial degree.

The present invention accordingly provides aqueous colorant preparations consisting essentially of
(A) 0.1% to 50% by weight and preferably 15% to 30% by weight of at least one organic and/or inorganic colorant,
(B) 0.1% to 30% by weight and preferably 0.2% to 10% by weight of at least one succinamate,
(C) 0.1% to 30% by weight and preferably 1% to 20% by weight of at least one polyethylene glycol alkyl ether,
(D) 0% to 30% by weight and preferably 0.1% to 10% by weight of at least one alkoxylated styrene-phenol condensate,
(E) 0% to 30% by weight and preferably 0.1% to 20% by weight of at least one organic solvent,
(F) 0% to 30% by weight and preferably 0.1% to 20% by weight of at least one hydrotropic substance,
(G) 0% to 10% by weight and preferably 0.1% to 5% by weight of further customary additives for ink jet preparations, and
(H) 10% to 90% by weight and preferably 30% to 80% by weight of deionized water,
   all based on the total weight (100% by weight) of the colorant preparation.

The present invention likewise provides aqueous colorant preparations consisting of
(A) 0.1% to 50% by weight and preferably 15% to 30% by weight of at least one organic and/or inorganic colorant,
(B) 0.1% to 30% by weight and preferably 0.2% to 10% by weight of at least one succinamate,
(C) 0.1% to 30% by weight and preferably 1% to 20% by weight of at least one polyethylene glycol alkyl ether,
(D) 0% to 30% by weight and preferably 0.1% to 10% by weight of at least one alkoxylated styrene-phenol condensate,
(E) 0% to 30% by weight and preferably 0.1% to 20% by weight of at least one organic solvent,
(F) 0% to 30% by weight and preferably 0.1% to 20% by weight of at least one hydrotropic substance,
(G) 0% to 10% by weight and preferably 0.1% to 5% by weight of further customary additives for ink jet preparations, and
(H) 10% to 90% by weight and preferably 30% to 80% by weight of deionized water,
   all based on the total weight (100% by weight) of the colorant preparation.

Component (A) of the colorant preparations according to the present invention is a finely divided organic or inorganic pigment and/or an organic dye or a mixture of various organic or inorganic pigments and/or organic dyes. The pigments can be used not only in the form of dry powders but also as water-moist presscakes.

Useful organic pigments include monoazo, disazo, laked azo, β-naphthol, Naphthol AS, benzimidazolone, condensed disazo, azo metal complex pigments and polycyclic pigments such as for example phthalocyanine, quinacridone, perylene, perinone, thioindigo, anthanthrone, anthraquinone, flavanthrone, indanthrone, isoviolanthrone, pyranthrone, dioxazine, quinophthalone, isoindolinone, isoindoline and diketopyrrolopyrrole pigments or carbon blacks.

Also useful are in particular surface-modified pigments whose surface has been altered by chemical operations such as for example sulfonation or diazotization and been provided with functional, neutral or charged groups or polymeric chains (these surface-modified pigments also being known as self-dispersing or graft pigments).

Useful inorganic pigments include for example titanium dioxides, zinc sulfides, iron oxides, chromium oxides, ultramarine, nickel or chromium antimony titanium oxides, cobalt oxides and also bismuth vanadates.

Useful organic dyes include acid dyes, direct dyes, sulfur dyes and their leuko form, metal complex dyes or reactive dyes; in the case of reactive dyes, dyes which have been reacted with nucleophiles can be used as well.

Of the organic pigments mentioned, particularly suitable ones are those whose lightfastness is better than 5 and in particular better than 6 on a blue scale. In addition, the pigments used should be very finely divided in that preferably 95% and more preferably 99% of the pigment particles have a particle size ≦500 nm. The average particle size is ideally <150 nm. Depending on the pigment used, the morphology of the pigment particles can vary widely, and accordingly the viscosity behavior of the pigment preparations can vary widely as a function of the particle shape. To achieve an ideal, newtonian viscosity behavior for the preparations, the particles should preferably have a cuboid shape. Preference is given to using pure or subsequently purified pigments comprising very few organic or inorganic impurities.

An illustrative selection of particularly preferred pigments are carbon black pigments, for example lampblacks, or furnace blacks; monoazo and disazo pigments, in particular the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 126, Pigment Yellow 127, Pigment Yellow 128, Pigment Yellow 155, Pigment Yellow 174, Pigment Yellow 176, Pigment Yellow 191, Pigment Red 38, Pigment Red 144, Pigment Red 214, Pigment Red 242, Pigment Red 262, Pigment Red 266, Pigment Red 269, Pigment Red 274, Pigment Orange 13, Pigment Orange 34 or Pigment Brown 41; β-naphthol and Naphthol AS pigments, in particular the Colour Index pigments Pigment Red 2, Pigment Red 3, Pigment Red 4, Pigment Red 5, Pigment Red 9, Pigment Red 12, Pigment Red 14, Pigment Red 53:1, Pigment Red 112, Pigment Red 146, Pigment Red 147, Pigment Red 170, Pigment Red 184, Pigment Red 187, Pigment Red 188, Pigment Red 210, Pigment Red 247, Pigment Red 253, Pigment Red 256, Pigment Orange 5, Pigment Orange 38 or Pigment Brown 1; laked azo and metal complex pigments, in particular the Colour Index pigments Pigment Red 48:2, Pigment Red 48:3, Pigment Red 48:4, Pigment Red 57:1, Pigment Red 257, Pigment Orange 68 or Pigment Orange 70; benzimidazoline pigments, in particular the Colour Index pigments Pigment Yellow 120, Pigment Yellow 151, Pigment Yellow 154, Pigment Yellow 175, Pigment Yellow 180, Pigment Yellow 181, Pigment Yellow 194, Pigment Red 175, Pigment Red 176, Pigment Red 185, Pigment Red 208, Pigment Violet 32, Pigment Orange 36, Pigment Orange 62, Pigment Orange 72 or Pigment Brown 25; isoindolinone and isoindoline pigments, in particular the Colour Index pigments Pigment Yellow 139 or Pigment Yellow 173; phthalocyanine pigments, in particular the Colour Index pigments Pigment Blue 15, Pigment Blue 15:1, Pigment Blue 15:2, Pigment Blue 15:3, Pigment Blue 15:4, Pigment Blue 16, Pigment Green 7 or Pigment Green 36; anthanthrone, anthraquinone, quinacridone, dioxazine, indanthrone, perylene, perinone and thioindigo pigments, in particular the Colour Index pigments Pigment Yellow 196, Pigment Red 122, Pigment Red 149, Pigment Red 168, Pigment Red 177, Pigment Red 179, Pigment Red 181, Pigment Red 207, Pigment Red 209, Pigment Red 263, Pigment Blue 60, Pigment Violet 19, Pigment Violet 23 or Pigment Orange 43; triarylcarbonium pigments, in particular the Colour Index pigments Pigment Red 169, Pigment Blue 56 or Pigment Blue 61; diketopyrrolopyrrole pigments, in particular the Colour Index pigments Pigment Red 254.

A selection of particularly preferred organic dyes are the Colour Index dyes Acid Yellow 17, Acid Yellow 23, Direct Yellow 86, Direct Yellow 98, Direct Yellow 132, Reactive Yellow 37, Acid Red 52, Acid Red 289, Reactive Red 23, Reactive Red 180, Acid Blue 9, Direct Blue 199 and the reaction products of reactive dyes with nucleophiles.

Component (B) is preferably selected from compounds of the formula (Ia) or (Ib) 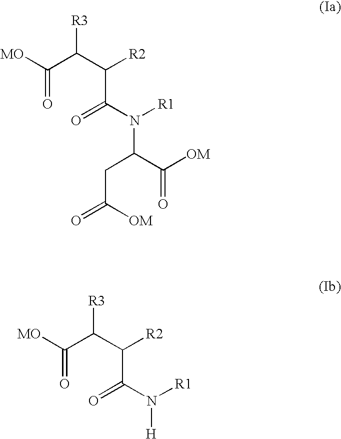
where
R¹ is H, a substituted or unsubstituted, branched or unbranched C₁-C₂₀-alkyl or C₃-C₂₀-cycloalkyl radical or a substituted or unsubstituted, branched or unbranched C₁-C₂₀-alkenyl or C₃-C₂₀-cycloalkenyl radical, the substituents preferably being 1, 2, 3 or 4 radicals from the group consisting of halogen, aryl, aryl(C₁-C₂₀)alkyl, hetaryl, hetaryl(C₁-C₂₀)alkyl or C₁-C₂₀-alkoxy,
R² and R³ are independently H, a substituted or unsubstituted, branched or unbranched C₁-C₂₀-alkyl or C₃-C₂₀-cycloalkyl radical or a substituted or unsubstituted, branched or unbranched C₁-C₂₀-alkenyl or C₃-C₂₀-cyclo-alkenyl radical, the substituents preferably being 1, 2, 3 or 4 radicals from the group consisting of halogen, hydroxyl, C₁-C₄-alkoxy, nitro, cyano, carboxyl, amino, sulfo, aryl, aryl(C₁-C₄)alkyl, hetaryl, hetaryl(C₁-C₄)alkyl, C₁-C₄-alkoxy, COOM, SO₃M, SO₂M and PO₃M₂, and
M is H, a univalent metal cation, NH₄⁺, a secondary, tertiary or quaternary ammonium ion.

“Aryl” here and also in the definitions below refers to an aromatic radical which preferably contains 6 to 15 carbon atoms. Examples thereof are phenyl, naphthyl, anthryl and phenanthryl.

“Hetaryl” here and also in the definitions below refers to an aromatic radical which preferably contains 1, 2, 3 or 4 heteroatoms from the group consisting of O, N, S and P as well as 1 to 10 carbon atoms. Examples thereof are pyrrolyl, furyl, thiophenyl, indolyl, isoindolyl, indolizinyl, benzofuryl, benzothiophenyl, pyrazolyl, imidazolyl, oxazolyl, isoxazolyl, thiazolyl, isothiazolyl, triazolyl, tetrazolyl, pyridyl, quinolinyl, isoquinolinyl, pyridazinyl, pyrimidinyl, pyrazinyl and triazinyl.

Particular preference here is given to compounds of the formula (IIa) or (IIb) 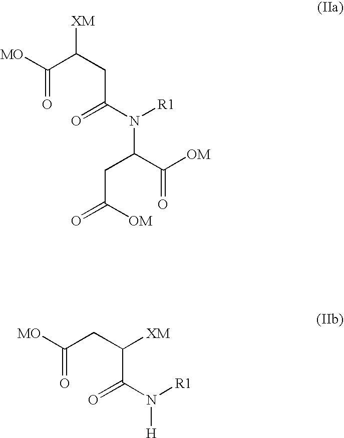
where
R¹ is H, a branched or unbranched C₁-C₂₀-alkyl radical or a branched or unbranched C₁-C₂₀-alkenyl radical, which may each be substituted as described above,
X is COO⁻, SO₃⁻, SO₂⁻ or PO₃M⁻ and
M is H, a univalent metal cation, NH₄⁺, a secondary, tertiary or quaternary ammonium ion.

In particularly preferred compounds of the formulae (Ia), (Ib), (IIa) and (IIb), R¹ is C₁₂-C₁₈-alkyl (branched or unbranched) or C₁₂-C₁₈-alkenyl (branched or unbranched), which may each be substituted by 1, 2, 3 or 4 substituents from the group consisting of halogen, aryl, aryl(C₁-C₄)alkyl, hetaryl, hetaryl(C₁-C₄)alkyl and C₁-C₄-alkoxy, X is preferably SO₃⁻ and M is preferably H⁺, Li⁺, Na⁺, K⁺, NH₄⁺, HO—CH₂—CH₂—NH₃⁺, (HO—CH₂—CH₂—)₂NH₂⁺ or (HO—CH₂—CH₂—)₃NH⁺.

Component (C) is preferably selected from the compounds of the formula (III) 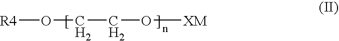
where
R⁴ is a substituted or unsubstituted, branched or unbranched C₁-C₂₀-alkyl or C₃-C₂₀-cycloalkyl radical or a substituted or unsubstituted, branched or unbranched C₁-C₂₀-alkenyl or C₃-C₂₀-cycloalkenyl radical, the substituents preferably being 1, 2, 3 or 4 radicals from the group consisting of halogen, aryl, aryl(C₁-C₂₀)alkyl, C₅-C₆-cycloalkyl, hetaryl, hetaryl(C₁-C₂₀)alkyl or C₁-C₂₀-alkoxy,
n is from 1 to 100, preferably from 1 to 20,
X is CH₂COO⁻, SO₃⁻, SO₂⁻ or PO₃M⁻, and
M is H, a univalent metal cation, NH₄⁺, a secondary, tertiary or quaternary ammonium ion.

In particularly preferred compounds of the formula (III) R⁴ is C₁₂-C₁₈-alkyl (branched or unbranched) or C₁₂-C₁₈-alkenyl (branched or unbranched), which may each be substituted by 1, 2, 3 or 4 substituents from the group consisting of halogen, aryl, aryl(C₁-C₄)alkyl, hetaryl, hetaryl(C₁-C₄)alkyl and C₁-C₄-alkoxy, X is preferably CH²COO⁻ and M is preferably H⁺, Li⁺, Na⁺, K⁺, NH₄⁺, HO—CH₂—CH₂—NH₃⁺, (HO—CH₂—CH₂—)₂NH₂⁺ or (HO—CH₂CH₂—)₃NH⁺.

Examples of compounds of the formula (III) are:

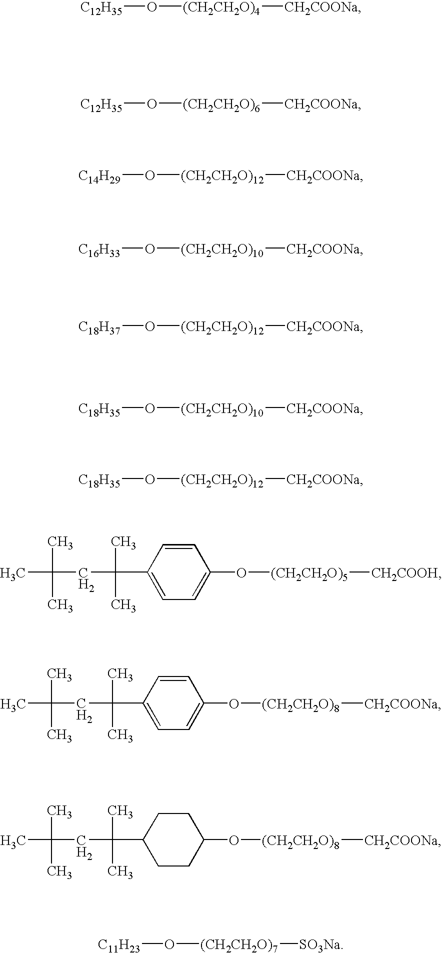

Compounds of this kind are known from CH-A-324 665 and CH-A-283 986.

Component (D) is preferably selected from the compounds of the formula (IV) or (V) or mixtures thereof 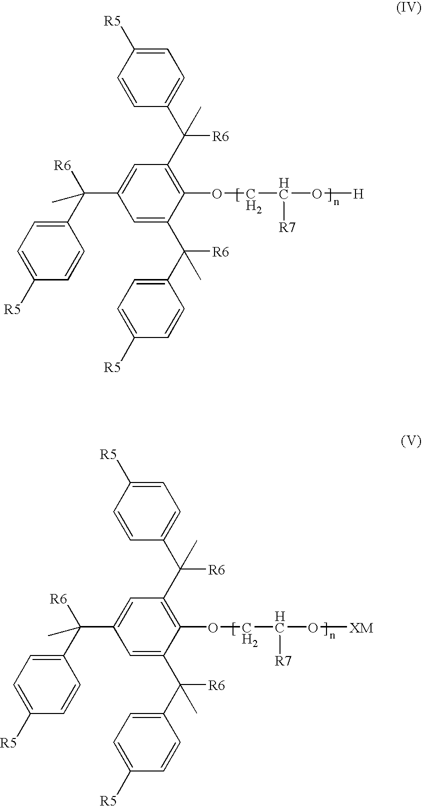
where
R⁵ is H, a branched or unbranched C₁-C₂₀-alkyl or C₃-C₂₀-cycloalkyl radical or a branched or unbranched C₁-C₂₀-alkenyl or C₃-C₂₀-cycloalkenyl radical, preferably H or a C₁-C₄-alkyl radical,
R⁶ and R⁷ are independently H, a branched or unbranched C₁-C₂₀-alkyl or C₃-C₂₀-cycloalkyl radical or a branched or unbranched C₁-C₂₀-alkenyl or C₃-C₂₀-cycloalkenyl radical, preferably H or CH₃,
n is from 1 to 100, preferably from 20 to 60,
X is CO—R₈—COO⁻, SO₃⁻, SO₂⁻ or PO₃M⁻,
R⁸ is a substituted or unsubstituted, branched or unbranched C₁-C₂₀-akylene radical, a substituted, unsubstituted, branched or unbranched C₁-C₂₀-alkenylene radical or a substituted or unsubstituted arylene radical, the substituents preferably being 1, 2, 3 or 4 radicals from the group consisting of halogen, hydroxyl, C₁-C₄-alkoxy, nitro, cyano, carboxyl, amino and sulfo, preferably CH═CH, CH(SO₃M)—CH₂ or CH₂—CH(SO₃M), and
M is H, a univalent metal cation, NH₄⁺, a secondary, tertiary or quaternary ammonium ion.

Preferred meanings of M are as defined above.

Compounds of this kind are known for example from DE-A-195 35 246 and DE-A-197 12 486.

The colorant preparations according to the invention may include as component (E) an organic solvent or a mixture of organic solvents, in which case these solvents may if desired possess a water-retaining effect. Useful solvents include for example mono- or polyhydric alcohols, their ethers and esters, for example alkanols, especially of 1 to 4 carbon atoms, for example methanol, ethanol, propanol, isopropanol, butanol, isobutanol; di- or trihydric alcohols, especially of 2 to 6 carbon atoms, e.g. ethylene glycol, propylene glycol, 1,3-propanediol, 1,4-butanediol, 1,5-pentanediol, 1,6-hexanediol, neopentyl glycol, 1,2,6-hexanetriol, glycerol, 2-ethyl-2-hydroxymethyl-1,3-propane diol, diethylene glycol, triethylene glycol, polyethylene glycol, dipropylene glycol, tripropylene glycol, polypropylene glycol; lower alkyl ethers of polyhydric alcohols, for example ethylene glycol monomethyl or ethyl or butyl ethers, triethylene glycol monomethyl or ethyl ethers; ketones and ketone alcohols, e.g., acetone, methyl ethyl ketone, diethyl ketone, methyl isobutyl ketone, methyl pentyl ketone, cyclopentanone, cyclohexanone, diacetone alcohol; amides, e.g., dimethylformamide, dimethylacetamide and N-methylpyrrolidone.

Useful hydrotropic compounds (F), which also serve as a solvent, if appropriate, include for example formamide, urea, tetramethylurea, ε-caprolactam, ethylene glycol, propylene glycol, diethylene glycol, triethylene glycol, polyethyleneglycol, butyl glycol, methylcellosolve, glycerol, N-methylpyrrolidone, 1,3-diethyl-2-imidazolidinone, thiodiglycol, sodium benzenesulfonate, sodium xylenesulfonate, sodium toluenesulfonate, sodium cumenesulfonate, sodium dodecylsulfonate, sodium benzoate, sodium salicylate or sodium butyl monoglycol sulfate.

The colorant preparations of the present invention may further include, as component (G), further additives customary for ink jet inks and in the printing and coatings industry in particular, such as for example preservatives, photostabilizers, antioxidants, cationic, anionic, amphoteric or nonionic surface-active substances (surfactants and wetting agents), degassers/defoamers and also agents for regulating the viscosity, for example polyvinyl alcohol, cellulose derivatives or water-soluble natural or artificial resins and polymers as film-formers or binders to enhance the adhesion and abrasion resistance. The pH regulators used include organic or inorganic bases and acids. Preferred organic bases are amines, for example ethanolamine, diethanolamine, triethanolamine, N,N-dimethylethanolamine, diisopropylamine, aminomethylpropanol or dimethylaminomethylpropanol. Preferred inorganic bases are sodium hydroxide, potassium hydroxide, lithium hydroxide or ammonia.

Water used to produce the colorant preparations, component (H), is preferably used in the form of distilled or demineralized water.

The present invention's combination of dispersants provides low viscosities, which is of substantial importance for applications in the ink jet sector specifically, and also rapid migration of the dispersant to ink droplet surface which newly forms during printing and thus to a stable and uniform formation of droplets. Ink jet prints of high quality are possible in this way.

Acrylate resins frequently used as dispersants, as well as some other polymers or copolymers having a relatively large number of terminal carboxyl radicals, tend to form insoluble complexes with multiply charged metal cations, such as Ca²⁺, Mg²⁺ or Fe³⁺ for example, which can lead to flocculation and hence to low stability of the dispersion in the presence of extraneous-salt impurities. Such metal impurities are often introduced into the dispersion by the pigment as a result of the process used to synthesize it, and this restricts the choice of suitable pigments. Such a negative influence of metal impurities is not observed with the dispersant system of the present invention. The dispersant system of the present invention is thus advantageously suitable for a large variety of pigments.

A further problem which is often associated with the use of polymers in ink jet inks is their tendency to solidify at the nozzles of the print head, which leads to nozzle clogging and hence to poor printing behavior. Such nozzle failure is not observed when dispersants of the present invention are used, making a nonstreaky and hence uniform print possible.

The invention further provides a process for producing a colorant preparation, which comprises the colorant (A), preferably as a powder or as a presscake, being pasted up together with the components (B), (C), and if appropriate (D), (E), (F) and/or (G) in deionized water (component H) and homogenized and being finely dispersed or finely divided by means of a grinding or dispersing assembly. Preferably, the process comprises a first step of at least one colorant (component A) either as a powder or as a presscake, being pasted up together with at least one dispersant based on a water-soluble sulfosuccinamate of the formula (Ia) or (Ib) (component B), at least one polyethylene glycol alkyl ether or its salt of the formula (III) (component C), if appropriate at least one alkoxylated styrene-phenol condensate of the formula (IV) or (V) or mixtures thereof (component D), if appropriate with at least one organic solvent (component E), if appropriate with at least one hydrotropic substance (component F) and if appropriate the other additives (component G) in deionized water (component H) and subsequently homogenized and predispersed using a dissolver or some other suitable apparatus. The fine-dispersion operation follows using a bead mill or some other suitable dispersing assembly to the desired particle size distribution for the colorant particles, in particular pigment particles, with cooling. After the fine dispersion operation, the dispersion can be further diluted with deionized water. The invention further provides for the use of the colorant preparation described as a colorant for printing inks, especially for ink jet inks, electrophotographic toners, especially polymerization tones, powder coatings and color filters.

By ink jet inks are meant not only waterborne inks (including microemulsions) but also solventborne inks, UV-curable inks and also hotmelt inks.

Waterborne ink jet inks comprise essentially 0.5% to 30% by weight and preferably 1% to 15% by weight of one or more of the colorant preparations according to the present invention, 70% to 95% by weight of water, 0% to 30% by weight of one or more hydrotropic, i.e., water-retaining, compounds and/or organic solvents. Waterborne ink jet inks may optionally further comprise water-soluble binders and further additives, for example surfactants and wetting agents, degassers/defoamers, preservatives and antioxidants.

Microemulsion inks are based on organic solvents, water and optionally an additional substance to act as an interface mediator (surfactant). Microemulsion inks include 0.5% to 30% by weight and preferably 1% to 15% by weight of one or more colorant preparations according to the invention, 0.5% to 95% by weight of water and 0.5% to 95% by weight of organic solvent and/or interface mediator.

Solventborne ink jet inks consist essentially of 0.5% to 30% by weight of one or more colorant preparations according to the invention, 70% to 95% by weight of an organic solvent or solvent mixture and/or of a hydrotropic compound. If desired, solventborne ink jet inks may include carrier materials and binders which are soluble in the solvent, for example polyolefins, natural and synthetic rubber, polyvinyl chloride, vinyl chloride-vinyl acetate copolymers, polyvinyl butyrals, wax/latex systems or combinations thereof.

UV-curable inks include essentially 0.5% to 30% by weight of one or more colorant preparations according to the invention, 0.5% to 95% by weight of water, 0.5% to 95% by weight of an organic solvent or solvent mixture, 0.5% to 50% by weight of a radiation-curable binder and optionally 0% to 10% by weight of a photoinitiator.

Hot melt inks are usually based on waxes, fatty acids, fatty alcohols or sulfonamides which are solid at room temperature and liquefy on heating, the preferred melting range being between about 60 and about 140° C. This invention also provides a hot melt ink jet ink consisting essentially of 20% to 90% by weight of wax and 1% to 10% by weight of one or more colorant preparations according to the invention. It may further include 0% to 20% by weight of an additional polymer (as “dye dissolver”), 0% to 5% by weight of dispersing assistant, 0% to 20% by weight of viscosity modifier, 0% to 20% by weight of plasticizer, 0% to 10% by weight of tack additive, 0% to 10% by weight of transparency stabilizer (which prevents for example crystallization of the wax) and also 0% to 2% by weight of antioxidant.

The present invention's printing inks, in particular ink jet inks, can be produced by dispersing the colorant preparations into the microemulsion medium or into the aqueous or nonaqueous medium or into the medium for preparing the UV-curable ink or into the wax for preparing a hotmelt ink jet ink.

Advantageously, the printing inks obtained are subsequently filtered (through a 1 μm filter for example) for ink jet applications.

The present invention further provides a set of printing inks which comprises printing inks in the colors black, cyan, magenta, yellow, if appropriate green and if appropriate orange and is characterized by at least one of the printing inks being or comprising a colorant preparation according to the invention.

Preference is given to a set of printing inks whose black preparation preferably comprises carbon black as colorant, in particular a lamp black or furnace black; whose cyan preparation preferably comprises a pigment from the group of the phthalocyanine, indanthrone or triarylcarbonium pigments, in particular the Colour Index pigments Pigment Blue 15, Pigment Blue 15:1, Pigment Blue 15:2, Pigment Blue 15:3, Pigment Blue 15:4, Pigment Blue 16, Pigment Blue 56, Pigment Blue 60 or Pigment Blue 61; whose magenta preparation preferably comprises a pigment from the group of the monoazo, disazo, β-naphthol, Naphthol AS, laked azo, metal complex, benzimidazolone, anthanthrone, anthraquinone, quinacridone, dioxazine, perylene, thioindigo, triarylcarbonium or diketopyrrolopyrrole pigments, in particular the Colour Index pigments Pigment Red 2, Pigment Red 3, Pigment Red 4, Pigment Red 5, Pigment Red 9, Pigment Red 12, Pigment Red 14, Pigment Red 38, Pigment Red 48:2, Pigment Red 48:3, Pigment Red 48:4, Pigment Red 53:1, Pigment Red 57:1, Pigment Red 112, Pigment Red 122, Pigment Red 144, Pigment Red 146, Pigment Red 147, Pigment Red 149, Pigment Red 168, Pigment Red 169, Pigment Red 170, Pigment Red 175, Pigment Red 176, Pigment Red 177, Pigment Red 179, Pigment Red 181, Pigment Red 184, Pigment Red 185, Pigment Red 187, Pigment Red 188, Pigment Red 207, Pigment Red 208, Pigment Red 209, Pigment Red 210, Pigment Red 214, Pigment Red 242, Pigment Red 247, Pigment Red 253, Pigment Red 254, Pigment Red 256, Pigment Red 257, Pigment Red 262, Pigment Red 263, Pigment Red 266, Pigment Red 269, Pigment Red 274, Pigment Violet 19, Pigment Violet 23 or Pigment Violet 32; whose yellow preparation preferably comprises a pigment from the group of the monoazo, disazo, benzimidazoline, isoindolinone, isoindoline or perinone pigments, in particular the Colour Index pigments Pigment Yellow 1, Pigment Yellow 3, Pigment Yellow 12, Pigment Yellow 13, Pigment Yellow 14, Pigment Yellow 16, Pigment Yellow 17, Pigment Yellow 73, Pigment Yellow 74, Pigment Yellow 81, Pigment Yellow 83, Pigment Yellow 87, Pigment Yellow 97, Pigment Yellow 111, Pigment Yellow 120, Pigment Yellow 126, Pigment Yellow 127, Pigment Yellow 128, Pigment Yellow 139, Pigment Yellow 151, Pigment Yellow 154, Pigment Yellow 155, Pigment Yellow 173, Pigment Yellow 174, Pigment Yellow 175, Pigment Yellow 176, Pigment Yellow 180, Pigment Yellow 181, Pigment Yellow 191, Pigment Yellow 194, Pigment Yellow 196 oder Pigment Yellow 213; whose orange preparation preferably comprises a pigment from the group of the disazo, β-naphthol, Naphthol AS, benzimidazolone or perinone pigments, in particular the Colour Index pigments Pigment Orange 5, Pigment Orange 13, Pigment Orange 34, Pigment Orange 36, Pigment Orange 38, Pigment Orange 43, Pigment Orange 62, Pigment Orange 68, Pigment Orange 70, Pigment Orange 72 or Pigment Orange 74; whose green preparation preferably comprises a pigment from the group of the phthalocyanine pigments, in particular the Colour Index pigments Pigment Green 7 or Pigment Green 36.

The printing inks of the present invention are useful in all conventional ink jet printers, in particular those which are based on the bubble jet or piezo process. As well as for printing paper, natural or synthetic fiber materials, films or plastics, the pigment preparations according to the invention can be used for printing a wide variety of coated or uncoated substrate materials, for example for printing paperboard, cardboard, wood and woodbase materials, metallic materials, semiconductor materials, ceramic materials, glasses, glass and ceramic fibers, inorganic materials of construction, concrete, leather, comestibles, cosmetics, skin and hair. The substrate material can be two-dimensionally planar or extend in space, i.e., be three-dimensional, and be printed or coated completely or only in parts.

The colorant preparations according to the invention are also useful as colorants in electrophotographic toners ard developers, for example one component and two component powder toners or developers, magnetic toners, liquid toners, polymerization toners and also other specialty toners. Typical toner binders are addition polymerization, polyaddition and polycondensation resins, e.g., styrene, styrene-acrylate, styrene-butadiene, acrylate, polyester or phenolic epoxy resins, poloysulfones and polyurethanes, individually or in combination, and also polyethylene and polypropylene, which may include yet further ingredients, such as charge control agents, waxes or flow agents, or may have added to them subsequently.

The colorant preparations according to the invention are further useful as colorants in powder coatings, especially in triboelectrically or electrostatically sprayed powder coatings which are used for surface coating articles made for example of metal, wood, plastic, glass, ceramic, concrete, textile material, paper or rubber. Useful powder coating resins typically include epoxy resins, carboxyl- and hydroxyl-containing polyester resins, polyurethanes and acrylic resins together with customary hardeners. Combinations of resins are also used. For instance, epoxy resins are frequently used in combination with carboxyl- and hydroxyl-containing polyester resins. Typical hardener components (depending on the resin system) are for example acid anhydrides, imidazoles and also dicyandiamide and their derivatives, capped isocyanates, bisacylurethanes, phenolic and melamine resins, triglycidyl isocyanurates, oxazolines and dicarboxylic acids.

The colorant preparations according to the invention are also useful as colorants for color filters and also for additive as well as subtractive color generation and also as colorants for electronic inks or electronic paper (“e paper”).

The colorant preparations of the present invention are also useful for pigmenting paints, including emulsion paints, dispersion varnishes, for printing inks, for example textile printing, flexographic printing, decorative printing or gravure printing inks, for wallpaper colors, for water-thinnable coating materials, for wood preservation systems, for viscose solution dyeing, for varnishes, for sausage casings, for seed, for glass bottles, for the mass coloration of roofing shingles, for renders, for woodstains, for colored pencil leads, felttip pens, artists' inks, pastes for ballpoint pens, chalks, laundering and cleaning compositions, shoecare products, coloration of latex products, abrasives and also for coloration of plastics and macromolecular materials.

It has been determined that the colorant preparations of the present invention have altogether advantageous application properties and optimally fulfill the aforementioned offices and requirements in ink jet printing in particular. The viscosity usually remains low (<15 mPa s at 400 s⁻¹ in the case of pigment preparations) and remains stable not only at room temperature but also in the course of 4 weeks of storage at 60° C. The pigment particles in the dispersion have an average particle size of <150 nm (determined by the CHDF method), and the particle size distribution changes only insignificantly during storage if at all. The inks produced from the preparations are notable in particular for markedly good behavior in ink jet printing and for good stability during storage and in the ink jet printing operation. Moreover, the prints produced are notable for their high light- and waterfastness.

### EXAMPLES

I. Production of a Pigment Preparation

The pigment, either as a powder or as a presscake, was pasted up in deionized water together with the dispersants, the organic solvents and the other additives and then homogenized and predispersed using a dissolver (for example from Pendraulik, model LD 50) or some other suitable apparatus. The subsequent fine dispersion was effected using a bead mill (for example a MiniZETA 03 from Netzsch) or else using some other suitable dispersing assembly, the grinding being effected with cooling to the desired pigment particle size distribution. Subsequently, the dispersion was adjusted with deionized water to the desired final pigment concentration.

The pigment preparations described in the exemples hereinbelow were produced by the process described above, the following constituents being used in the stated amounts such that 100 parts of the respective pigment preparation were produced:

### Example 1

| | | |
|---|---|---|
| 20 | parts of | C.I. Pigment Yellow 155 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 2 | parts of | dispersant (IV) (R⁵/R⁶/R⁷ = H, n = 20) |
| 10 | parts of | propylene glycol |
| 0.2 | part of | preservative |

| | |
|---|---|
| Balance | water |

### Example 2

| | | |
|---|---|---|
| 20 | parts of | C.I. Pigment Red 122 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 2 | parts of | dispersant (IV) (R⁵/R⁶/R⁷ = H, n = 20) |
| 10 | parts of | propylene glycol |
| 0.2 | part of | preservative |

| | |
|---|---|
| Balance | water |

### Example 3

| | | |
|---|---|---|
| 20 | parts of | C.I. Pigment Blue 15:3 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 2 | parts of | dispersant (IV) (R⁵/R⁶/R⁷ = H, n = 20) |
| 10 | parts of | propylene glycol |
| 0.2 | part of | preservative |

| | |
|---|---|
| Balance | water |

### Example 4

| | | |
|---|---|---|
| 20 | parts of | C.I. Pigment Yellow 155 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 2 | parts of | dispersant (IV) (R⁵/R⁶/R⁷ = H, n = 29) |
| 10 | parts of | propylene glycol |
| 0.2 | part of | preservative |

| | |
|---|---|
| Balance | water |

### Example 5

| | | |
|---|---|---|
| 20 | parts of | C.I. Pigment Red 122 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 1 | part of | dispersant (IV) (R⁵/R⁶/R⁷ = H, n = 54) |
| 10 | parts of | propylene glycol |
| 0.2 | part of | preservative |

| | |
|---|---|
| Balance | water |

### Example 6

| | | |
|---|---|---|
| 20 | parts of | C.I. Pigment Blue 15:3 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 1 | part of | dispersant (IV) (R⁵/R⁶/R⁷ = H, n = 54) |
| 10 | parts of | propylene glycol |
| 0.2 | part of | preservative |

| | |
|---|---|
| Balance | water |

### Example 7

| | | |
|---|---|---|
| 20 | parts of | C.I. Pigment Yellow 155 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 1.2 | parts of | Emulgator 374 emulsifier (arylethylphenyl |
| | | polyglycol ether, Bayer AG) |
| 10 | parts of | propylene glycol |
| 0.2 | part of | preservative |

| | |
|---|---|
| Balance | water |

### Example 8

| | | |
|---|---|---|
| 20 | parts of | C.I. Pigment Red 122 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 1.2 | parts of | Emulgator 374 emulsifier (arylethylphenyl |
| | | polyglycol ether, Bayer AG) |
| 10 | parts of | propylene glycol |
| 0.2 | part of | preservative |

| | |
|---|---|
| Balance | water |

### Example 9

| | | |
|---|---|---|
| 20 | parts of | C.I. Pigment Blue 15:3 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 1.2 | parts of | Emulgator 374 emulsifier (arylethylphenyl |
| | | polyglycol ether, Bayer AG) |
| 10 | parts of | propylene glycol |
| 0.2 | part of | preservative |

| | |
|---|---|
| Balance | water |

### Example 10

| | | |
|---|---|---|
| 20 | parts of | C.I. Pigment Yellow 155 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 10 | parts of | propylene glycol |
| 0.2 | part of | preservative |

| | |
|---|---|
| Balance | water |

### Example 11

| | | |
|---|---|---|
| 20 | parts of | C.I. Pigment Red 122 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 10 | parts of | propylene glycol |
| 0.2 | part of | preservative |

| | |
|---|---|
| Balance | water |

### Example 12

| | | |
|---|---|---|
| 20 | parts of | C.I. Pigment Blue 15:3 |
| 0.7 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 10 | parts of | propylene glycol |
| 0.2 | part of | preservative |

| | |
|---|---|
| Balance | water |

### Example 13

| | | |
|---|---|---|
| 20 | parts of | C.I. Pigment Red 122 |
| 0.7 | part of | sulfosuccinamate of formula (IIb) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 10 | parts of | propylene glycol |
| 0.2 | part of | preservative |

| | |
|---|---|
| Balance | water |

### Example 14

| | | |
|---|---|---|
| 20 | parts of | C.I. Pigment Blue 15:3 |
| 0.7 | part of | sulfosuccinamate of formula (IIb) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 10 | parts of | propylene glycol |
| 0.2 | part of | preservative |

| | |
|---|---|
| Balance | water |

### Example 15

| | | |
|---|---|---|
| 15 | parts of | carbon black pigment (C.I. Pigment Black 7) |
| 0.2 | part of | sulfosuccinamate of formula (IIa) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 1.1 | parts of | dispersant (IV) (R⁵/R⁶/R⁷ = H, n = 20) |
| 0.7 | part of | dispersant (V) (R⁵/R⁶/R⁷ = H, n = 20, |
| | | X = PO₃M⁻, M = (HO—CH₂—CH₂—)₃NH⁺) |
| 10 | parts of | propylene glycol |
| 0.2 | part of | preservative |

| | |
|---|---|
| Balance | water |

### Example 16

| | | |
|---|---|---|
| 15 | parts of | carbon black pigment (C.I. Pigment Black 7) |
| 0.2 | part of | sulfosuccinamate of formula (IIb) |
| | | (R¹ = C₁₈H₃₇, X = SO₃⁻, M = Na) |
| 3 | parts of | dispersant (III) (R⁴ = C₁₈H₃₅, n = 12, |
| | | X = CH₂COO⁻, M = Na) |
| 1.1 | parts of | dispersant (IV) (R⁵/R⁶/R⁷ = H, n = 20) |
| 0.7 | part of | dispersant (V) (R⁵/R⁶/R⁷ = H, n = 20, |
| | | X = PO₃M⁻, M = (HO—CH₂—CH₂—)₃NH⁺) |
| 10 | parts of | propylene glycol |
| 0.2 | part of | preservative |

| | |
|---|---|
| Balance | water |

### Comparative Example 1

| | |
|---|---|
| 20 parts of | C.I. Pigment Yellow 155 |
| 8 parts of | ethoxylated naphthalene derivative of formula (VI) |
| 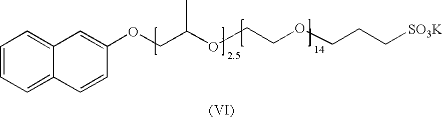 | |
| 1.5 parts of | ethoxylated naphthalene derivative of formula (VII) |
| 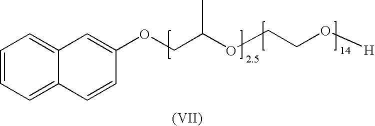 | |
| 0.7 part of | sulfosuccinate of formula (VIII) |
| 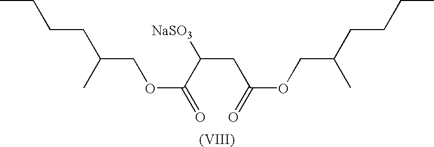 | |
| 10 parts of | propylene glycol |
| 0.2 part of | preservative |
| Balance | water |

### Comparative Example 2

| | | |
|---|---|---|
| 20 | parts of | C.I. Pigment Yellow 155 |
| 8 | parts of | ethoxylated naphthalene derivative |
| | | of formula (VI) |
| 1.5 | parts of | ethoxylated naphthalene derivative |
| | | of formula (VII) |
| 3 | parts of | dispersant (III) (R⁴ = C₁₈H₃₅, n = 12, |
| | | X = CH₂COO⁻, M = Na) |
| 10 | parts of | propylene glycol |
| 0.2 | part of | preservative |

| | |
|---|---|
| Balance | water |

### Comparative Example 3

| | | |
|---|---|---|
| 20 | parts of | C.I. Pigment Yellow 155 |
| 8 | parts of | ethoxylated naphthalene derivative |
| | | of formula (VI) |
| 1.5 | parts of | ethoxylated naphthalene derivative |
| | | of formula (VII) |
| 0.7 | part of | sulfosuccinate of formula (VIII) |
| 3 | parts of | dispersant (III) (R⁴ = C₁₈H₃₅, n = 12, |
| | | X = CH₂COO⁻, M = Na) |
| 10 | parts of | propylene glycol |
| 0.2 | part of | preservative |

| | |
|---|---|
| Balance | water |

### Comparative Example 4

| | | |
|---|---|---|
| 20 | parts of | C.I. Pigment Yellow 155 |
| 10 | parts of | sulfosuccinamate of formula (IIa) |
| | | (R¹ = C₁₈H₃₇, X = SO₃⁻, M = Na) |
| 10 | parts of | propylene glycol |
| 0.2 | part of | preservative |

| | |
|---|---|
| Balance | water |

II Investigation of Physical Properties

Pigment preparations useful for ink jet printing have to fulfill a number of physical properties: they shall possess a very low viscosity (preferably <50 mPas), i.e., be readily flowable, even at comparatively high pigment concentrations. The dispersed pigment particles shall be very finely divided, i.e., the median particle size D₅₀ should not exceed a value of 150 nm.

The physical properties of the pigment formulations were investigated using the following methods and equipment:

Viscosity

Viscosity was determined using a Kaake (Roto Visco 1) cone-plate viscometer (titanium: Ø 60 mm, 1°), by investigating the dependence of the viscosity on the shear rate in a range between 0 and 700 s⁻¹. The viscosity values mentioned in Table 1 were measured at a shear rate of 400 s⁻¹. To evaluate the stability of the dispersions in storage, their viscosity was measured (1) directly after production of the preparation, (2) after one week of storage at 60° C. and (3) after four weeks of storage at 60° C.

Particle Sizes

The D₅₀ median particle sizes of the preparations were determined by the capillary hydrodynamic fractioning (CHDF) method.

pH

pH was determined using an inoLab pH/Cond pH meter from WTW.

Table 1 below gives an overview of the physical properties of the various pigment preparations mentioned in the examples:

TABLE 1

| | | Viscosity at 400 s⁻¹ [mPa · s] | | | |
|---|---|---|---|---|---|
| | pH | fresh | 1 week/60° C. | 4 weeks/60° C. | D₅₀ [nm] |
| Example | | | | | |
| 1 | 7.2 | 9.4 | 39.1 | 33.8 | 109.7 |
| 2 | 9.1 | 5.4 | 14.8 | 75.3 | 84.6 |
| 3 | 8.3 | 5.8 | 7.7 | 8.5 | 77.2 |
| 4 | 7.2 | 9.3 | 23.3 | 18.2 | 129.7 |
| 5 | 8.9 | 11.5 | 10.6 | 10.0 | 85.5 |
| 6 | 7.9 | 7.3 | 6.5 | 8.7 | 85.5 |
| 7 | 7.4 | 6.7 | 12.4 | 13.8 | 120.8 |
| 8 | 9.4 | 8.7 | 9.1 | 10.1 | 72.7 |
| 9 | 7.9 | 5.2 | 8.2 | 8.4 | 72.6 |
| 10 | 7.2 | 6.1 | 7.3 | 6.6 | 115.4 |
| 11 | 8.8 | 8.8 | 7.6 | 4.6 | 85.5 |
| 12 | 7.8 | 5.8 | 7.4 | 6.8 | 85.2 |
| 13 | 9.4 | 7.8 | 10.6 | 9.8 | 85.2 |
| 14 | 7.8 | 7.1 | 6.5 | 6.9 | 91.0 |
| 15 | 7.0 | 5.9 | 21.6 | 30.2 | 79.3 |
| 16 | 7.0 | 6.5 | 25.2 | 31.7 | 73.9 |
| comparative | | | | | |
| 1 | 5.9 | 39.5 | 23.6^{b} | 25.8^{b} | 101.2 |
| 2 | 6.1 | 69.9 | 38.5^{b} | 32.0^{b} | 125.3 |
| 3 | 6.1 | 67.2 | 23.1^{b} | 39.5^{b} | 120.5 |
| 4 | 7.9 | 157.4 | —^{a} | —^{a} | 145.8 |

^{a}Sample solidifies in the course of storage.
^{b}Pronouced flocculation and sedimentation occurs during hot storage.

All the examples of pigment preparations according to the present invention that are listed in Table 1 possess, as required, excellent flowability. The viscosities of the fresh samples were <15 mPas without exception. The measured results show that only very minimal viscosity changes occur as a result of storage at 60° C., apart from a few exceptions; that is, the dispersions are stable in storage. Furthermore, the D₅₀ median particle size of all pigment preparations according to the present invention is below 150 nm, these inventive pigment preparations accordingly meet the requirements expected of pigment concentrates for ink jet printing.

III Testing of Printing Properties of Pigment Preparations

Knowledge of the physical properties of pigment preparations is not sufficient to make a statement about their suitability for ink jet printing. In thermal ink jet (bubble jet) printing especially, the behavior of the pigment dispersions during the printing process in the nozzles is important. The large albeit brief thermal stresses must not cause the pigment dispersion to decompose, for example in that the dispersant molecules desorb from the pigment surface because this would cause the pigment particles to agglomerate. Such decomposition processes could on the one hand lead to cogation and on the other over time to nozzle clogging by the decomposition products.

The suitability of pigment preparations for producing inks for the ink jet process can thus only be judged by carrying out printing tests. To evaluate the printing properties of the pigment preparations, the preparations were used to produce test inks whose printability was investigated using a thermal ink jet printer (cf. Table 2).

To produce the test inks, the pigment preparations were initially finely filtered through a 1 μm filter to remove grinding media attritus and any coarse fractions. Thereafter, the filtered preparations were diluted with water and admixed with further low molecular weight alcohols and polyols. The test inks for yellow, magenta and cyan then had the following composition:

| | |
|---|---|
| 25 parts of | pigment preparation (cf. Examples 1 to 14) |
| 10 parts of | ethylene glycol |
| 10 parts of | diethylene glycol |
| 50 parts of | demineralized water |

The test inks for black then had the following composition:

| | |
|---|---|
| 33 parts of | pigment preparation (cf. Examples 15 and 16) |
| 10 parts of | ethylene glycol |
| 10 parts of | diethylene glycol |
| 47 parts of | demineralized water |

This corresponds to a 5% by weight pigment fraction in the respective ink.

The composition of the test inks was chosen so that the viscosity was in a range from 1.5 to 5 mPas. Surface tension, after viscosity the second important physical parameter of printing inks, determines the interaction of the ink with the print head, for example the wetting of the nozzle ducts, but also the formation of the ink droplets and also their shape and size. To adjust the surface tension of the inks to a value needed for optimal printing performance, it may be necessary to admix the ink with small amounts of surfactant.

The test inks were characterized using the following methods and equipment:

Surface Tension

The surface tension of the test inks was determined using a K 10 T digital tensiometer from Krüss GmbH (Hamburg). The values recorded in Table 2 are means of 10 successive measurements.

Printing Behavior

Printing behavior was evaluated against the two following assessment criteria:

(1) Print Head Jet Formation Behavior of Ink

A specific measuring arrangement (HP Print RIG with Optica System) from Vision Jet was used to investigate the behavior of the test inks in ink jet printing using an HP 420 thermal ink jet printer from Hewlett Packard. A video camera can be used to investigate the behavior of the ink jets during the printing operation at individual nozzles of the ink jet print head. The video images provide information as to how the pigmented ink behaves in the course of the formation of the ink jets, whether the ink is expelled from the nozzles of the print head in the form of straight, linear jets, whether individual drops are formed or whether the drops have satellites. The investigations provide additional information on the shape of ink drops and indicate irregularities in drop formation, for example due to cloggages of individual nozzles.

(2) Investigation of Printing Behavior on Paper

In addition, the HP 420 printer was used to print test images on commercially available normal papers (copy papers) and specialty papers (premium quality) from Hewlett Packard. The evaluation of the prints with regard to quality and finish of the printed image was done by purely visual inspection. It was noted whether the paper was greatly moistened, whether the pigment penetrated into the paper or whether the pigment remained stuck to the surface of the paper. It was further noted to what extent fine lines were perfectly reproduced, whether the ink spread out on the paper, resulting in low resolution, or whether it was possible to produce high resolution prints. The start of print behavior was investigated after prolonged pauses in the printing to see whether a good and flawless print was ensured instantly or whether individual nozzle channels were clogged by the ink drying, which led to a poor printed image.

The criteria (1) and (2) were used to evaluate the printing behavior or the print quality of the inks on the following scale from 1 to 6 (cf. Table 2):

1—Very good printed image, lovely uniform drop formation

6—Ink will not print, clogging of print head

TABLE 2

| Example | Surface tension [mN/m] | Print quality |
|---|---|---|
| 1 | 38 | 2 |
| 2 | 41 | 1 |
| 3 | 38 | 2 |
| 4 | 40 | 2 |
| 5 | 43 | 2 |
| 6 | 42 | 2 |
| 7 | 42 | 1 |
| 8 | 43 | 1 |
| 9 | 42 | 1 |
| 10 | 41 | 1 |
| 11 | 46 | 2 |
| 12 | 44 | 2 |
| 13 | 42 | 2 |
| 14 | 42 | 2 |
| 15 | 43 | 1 |
| 16 | 43 | 1 |

The pigment preparations presented in the examples (Table 2) were used to produce test inks which demonstrated good to very good printing behavior on an HP 420 printer. The surface tension of the test inks was in a range from 38 to 46 mN/n

The pigment preparations thus fully meet ink jet printing requirements with regard to physical and printing properties and so are ideal for use in ink jet printing.

1. An aqueous colorant preparation consisting essentially of
(A) 0.1% to 50% by weight and of at least one colorant selected from the group consisting of an organic colorant, inorganic colorant or a mixture thereof,
(B) 0.1% to 30% by weight of at least one succinamate,
(C) 0.1% to 30% by weight of at least one polyethylene glycol alkyl ether of the formula (III) 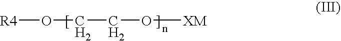
wherein
R⁴ is a substituted or unsubstituted, branched or unbranched C₁-C₂₀-alkyl or C₃-C₂₀-cycloalkyl radical or a substituted or unsubstituted, branched or unbranched C₁-C₂₀-alkenyl or C₃-C₂₀-cycloalkenyl radical, the substituents being 1, 2, 3 or 4 radicals selected from the group consisting of halogen, aryl, aryl(C₁-C₂₀)alkyl, C₅-C₆-cycloalkyl, hetaryl, hetaryl(C₁-C₂₀)alkyl and C₁-C₂₀-alkoxy,
n is from 1 to 100,
X is CH₂COO⁻, SO₃⁻, SO₂⁻ or PO₃M⁻, and
M is H, a univalent metal cation, NH₄⁺, a secondary, tertiary or quaternary ammonium ion,
(D) 0% to 30% by weight of at least one alkoxylated styrene-phenol condensate,
(E) 0% to 30% by weight of at least one organic solvent,
(F) 0% to 30% by weight of at least one hydrotropic substance,
(G) 0% to 10% by weight of at least one additive, and
(H) 10% to 90% by weight of deionized water,
all based on the total weight of the colorant preparation.

2. The colorant preparation according to claim 1 wherein the at least one succinamate (B) is of the formula (Ia) or 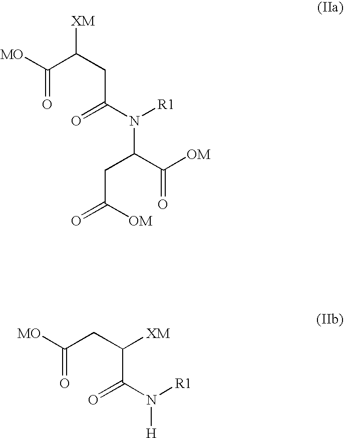
wherein
R¹ is H, a substituted or unsubstituted, branched or unbranched C₁-C₂₀-alkyl or C₃-C₂₀-cycloalkyl radical or a substituted or unsubstituted, branched or unbranched C₁-C₂₀-alkenyl or C₃-C₂₀-cycloalkenyl radical, the substituents being 1, 2, 3 or 4 radicals selected from the group consisting of halogen, aryl, aryl(C₁-C₂₀)alkyl, hetaryl, hetaryl(C₁-C₂₀)alkyl and C₁-C₂₀-alkoxy,
R² and R³ are independently H, a substituted or unsubstituted, branched or unbranched C₁-C₂₀-alkyl or C₃-C₂₀-cycloalkyl radical or a substituted or unsubstituted, branched or unbranched C₁-C₂₀-alkenyl or C₃-C₂₀-cycloalkenyl radical, the substituents being 1, 2, 3 or 4 radicals selected from the group consisting of halogen, hydroxyl, C₁-C₄-alkoxy, nitro, cyano, carboxyl, amino, sulfo, aryl, aryl(C₁-C₄)alkyl, hetaryl, hetaryl(C₁-C₄)alkyl, C₁-C₄-alkoxy, COOM, SO₃M, SO₂M and PO₃M₂, and
M is H, a univalent metal cation, NH₄⁺, a secondary, tertiary or quaternary ammonium ion.

3. The colorant preparation according to claim 1 wherein the at least one alkoxylated styrene-phenol condensate (D) is of the formula (IV), (V) or a mixture thereof 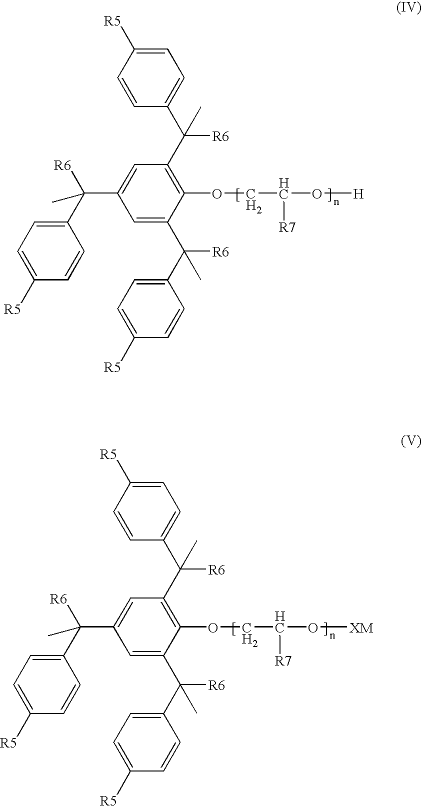
wherein
R⁵ is H, a branched or unbranched C₁-C₂₀-alkyl or C₃-C₂₀-cycloalkyl radical or a branched or unbranched C₁-C₂₀-alkenyl or C₃-C₂₀-cycloalkenyl radical,
R⁶ and R⁷ are independently H, a branched or unbranched C₁-C₂₀-alkyl or C₃-C₂₀-cycloalkyl radical or a branched or unbranched C₁-C₂₀-alkenyl or C₃-C₂₀-cycloalkenyl radical,
n is from 1 to 100,
X is CO—R₈—COO⁻, SO₃⁻, SO₂⁻ or PO₃M⁻,
R⁸ is a substituted or unsubstituted, branched or unbranched C₁-C₂₀-akylene radical, a substituted, unsubstituted, branched or unbranched C₁-C₂₀-alkenylene radical or a substituted or unsubstituted arylene radical, and
M is H, a univalent metal cation, NH₄⁺, a secondary, tertiary or quaternary ammonium ion.

4. The colorant preparation according to claim 1, wherein the at least one colorant is at least one organic colorant, wherein the at least one organic colorant is one or more organic pigments, one or more dyes, or a mixture thereof, wherein the one or more organic pigments are selected from the group consisting of monoazo, disazo, laked azo, β-naphthol, Naphthol AS, benzimidazolone, condensed disazo, azo, metal complex, phthalocyanine, quinacridone, perylene, perinone, thioindigo, anthanthrone, anthraquinone, flavanthrone, indanthrone, isoviolanthrone, pyranthrone, dioxazine, quinophthalone, isoindoline, isoindolinone diketopyrrolopyrrole pigments and carbon black, and wherein the one or more dyes are selected from the group consisting of an acid dye, direct dye, sulfur dye the leuco form of a sulfur dye, metal complex dye, reactive dye and a reaction product of a reactive dye with a nucleophile.

5. A process for producing a colorant preparation according to claim 1, comprising the steps of pasting up component (A) with components (B), (C), and optionally at least one of components (D), (E), (F) or (G) in component (H) to form a mixture, homogenizing the mixture and finely dispersing or finely dividing the mixture by grinding or dispersing assembly.

6. A method of using a colorant preparation according to one claim 1, comprising the step of coloring a composition or article with the colorant preparation, wherein the composition or article is selected from the group consisting of printing inks, ink jet inks, electrophotographic toners, polymerization toners, power coatings, color filters, electronic inks, electronic paper, paints, emulsion paints, dispersion varnishes, printing inks, wallpaper colors, water-thinnable coating materials, wood preservation systems, viscose solution dyeing, varnishes, sausage casings, seed, glass bottles, roofing shingles, renders, woodstains, colored pencil leads, felttip pens, artists' inks, pastes for ballpoint pens, chalks, laundering compositions, cleaning compositions, shoecare products, latex products, abrasives and plastics and macromolecular materials.

7. A printing ink set comprising a black printing ink, a cyan printing ink, a magenta printing ink, a yellow printing ink, optionally, an orange printing ink and optionally, a green printing ink, wherein at least one of the printing inks includes a colorant preparation according to claim 1.

8. The set of printing inks according to claim 7 wherein
the colorant of the black printing ink is a carbon black.

9. The colorant preparation according to claim 1, comprising 15% to 30% by weight of the at least one organic colorant, inorganic colorant or mixture thereof.

10. The colorant preparation according to claim 3, wherein the substituents of R₈ are 1, 2, 3 or 4 radicals from the group consisting of halogen, hydroxyl, C₁-C₄-alkoxy, nitro, cyano, carboxyl, amino and sulfo.

11. A composition or article colored with a colorant composition as claimed in claim 1, wherein the composition or article is selected from the group consisting of printing inks, ink jet inks, electrophotographic toners, polymerization toners, power coatings, color filters, electronic inks, electronic paper, paints, emulsion paints, dispersion varnishes, printing inks, wallpaper colors, water-thinnable coating materials, wood preservation systems, viscose solution dyeing, varnishes, sausage casings, seed, glass bottles, roofing shingles, renders, woodstains, colored pencil leads, felttip pens, artists' inks, pastes for ballpoint pens, chalks, laundering compositions, cleaning compositions, shoecare products, latex products, abrasives and plastics and macromolecular materials.

12. The printing ink set according to claim 7, wherein the colorant of the cyan printing ink is a pigment selected from the group of the phthalocyanine, indanthrone and triarylcarbonium pigments.

13. The printing ink set according to claim 7, wherein the colorant of the magneta printing ink is a pigment selected from the group consisting of monoazo, disazo, β-naphthol, Naphthol AS, laked azo, metal complex, benzimidazolone, anthanthrone, anthraquinone, quinacridone, dioxazine, perylene, thioindigo, triarylcarbonium and diketopyrrolopyrrole pigments.

14. The printing ink set according to claim 7, wherein the colorant of the yellow printing ink is a pigment selected from the group consisting of monoazo, disazo, benzimidazoline, isoindolinone, isoindoline and perinone pigments

15. The printing ink set according to claim 7, wherein the colorant of the orange printing ink is a pigment selected from the group consisting of disazo, β-naphthol, Naphthol AS, benzimidazolone and perinone pigments.

16. The printing ink set according to claim 7, wherein the colorant of the green colorant preparation is a phthalocyanine pigment.

17. The printing ink set according to claim 7, wherein at least one printing ink includes at least one organic dye selected from the group consisting of acid dyes, direct dyes, sulfur dyes and their leuco form, metal complex dyes and reactive dyes.
